(19) United States
(12) Patent Application Publication
(10) Pub. No.: US 2026/0012451 A1
(43) Pub. Date: Jan. 8, 2026

(54) AUTHENTICATION DEVICE, AUTHENTICATION SYSTEM, AUTHENTICATION METHOD, AND NON-TRANSITORY COMPUTER-READABLE STORAGE MEDIUM

(71) Applicant: CANON KABUSHIKI KAISHA, Tokyo (JP)

(72) Inventor: HIDEO KUBOYAMA, Kanagawa (JP)

(21) Appl. No.: 19/254,166

(22) Filed: Jun. 30, 2025

(30) Foreign Application Priority Data
Jul. 5, 2024 (JP) 2024-109091

(51) Int. Cl. H04L 9/40

(52) U.S. Cl. CPC H04L 63/083

(57) ABSTRACT

An authentication device comprises an authentication unit configured to authenticate by a first authentication method a user for whom a second authentication method, which is different from the first authentication method, has not been set and authenticate by the first authentication method and the second authentication method a user for whom the second authentication method has been set, and a setting unit configured to determine whether authentication by the second authentication method is necessary for the user for whom the second authentication method has not been set and if it is determined to be necessary, set information indicating that authentication by the second authentication method is necessary.

### BACKGROUND

### Field of the Technology

The present disclosure relates to a technique for authenticating a user.

### Description of the Related Art

In authentication devices that authenticate users, two-step authentication and multi-factor authentication, in which both authentication by a first authentication method using an ID, a password, and the like, and authentication by a second authentication method using authentication information based on held information and biometric information of the user are implemented, are popular. As authentication based on held information, there is a method in which a one-time password is notified from the authentication device to a phone number or email address of the user by SMS, email, or the like. In addition, there is a method of authenticating with a one-time password generated based on the time and a secret shared between the device owned by the user and the authentication device, using a Time-based One-Time Password (TOTP) method.

At this time, the organization to which the user belongs may require multi-factor authentication as an authentication policy. Japanese Patent Laid-Open No. 2020-531990 discloses, as a method for setting two-step authentication, upon verifying the password, sending a shared secret to the client, generating a one-time passcode based on the shared secret at the client, and verifying it on the server, thereby setting second authentication.

In the authentication device, in two-step authentication and multi-factor authentication, authentication is performed only by the first authentication method for users for whom authentication by the second authentication method, which is performed in addition to authentication by the first authentication method, has not been set. However, here, based on the authentication policy of the organization, the authentication device wants to request the user to set the second authentication method. Here, there are cases where the authentication device and the service providing device are separate and the service providing device, which is a login destination after authentication in the authentication device, has a screen for setting the second authentication method. In the service providing device, in order to determine whether the second authentication method is set for the logged-in user and whether to request that the user set the second authentication method, respective setting values need to be confirmed with the authentication device, which manages user information and tenant information of the organization. Therefore, the number of communications between the service providing device and the authentication device increases with each login, resulting in a delay before the service is provided after the login.

### SUMMARY

The present disclosure provides a technique for allowing determination as to whether authentication by a second authentication method is necessary for a user for whom the second authentication method has not been set, without increasing the number of communications with the authentication device, in another device different from the authentication device.

According to the first aspect of the present disclosure, there is provided an authentication device comprising: an authentication unit configured to authenticate by a first authentication method a user for whom a second authentication method, which is different from the first authentication method, has not been set and authenticate by the first authentication method and the second authentication method a user for whom the second authentication method has been set; and a setting unit configured to determine whether authentication by the second authentication method is necessary for the user for whom the second authentication method has not been set and if it is determined to be necessary, set information indicating that authentication by the second authentication method is necessary.

According to the second aspect of the present disclosure, there is provided an authentication system including an authentication device and a service providing device, the authentication device comprising: an authentication unit configured to authenticate by a first authentication method a user for whom a second authentication method, which is different from the first authentication method, has not been set and authenticate by the first authentication method and the second authentication method a user for whom the second authentication method has been set; and a setting unit configured to determine whether authentication by the second authentication method is necessary for the user for whom the second authentication method has not been set and if it is determined to be necessary, set information indicating that authentication by the second authentication method is necessary, the service providing device comprising: a processing unit configured to, in a case where the information is set, perform processing for setting authentication by the second authentication method for the user for whom the second authentication method has not been set.

According to the third aspect of the present disclosure, there is provided an authentication method performed by an authentication device, the method comprising: authenticating by a first authentication method a user for whom a second authentication method, which is different from the first authentication method, has not been set and authenticating by the first authentication method and the second authentication method a user for whom the second authentication method has been set; and determining whether authentication by the second authentication method is necessary for the user for whom the second authentication method has not been set and if it is determined to be necessary, setting information indicating that authentication by the second authentication method is necessary.

According to the fourth aspect of the present disclosure, there is provided a non-transitory computer-readable storage medium storing a computer program for causing a computer to function as: an authentication unit configured to authenticate by a first authentication method a user for whom a second authentication method, which is different from the first authentication method, has not been set and authenticate by the first authentication method and the second authentication method a user for whom the second authentication method has been set; and a setting unit configured to determine whether authentication by the second authentication method is necessary for the user for whom the second authentication method has not been set and if it is determined to be necessary, set information indicating that authentication by the second authentication method is necessary.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a configuration of an authentication system.

FIG. 2 is a block diagram illustrating an example of a hardware configuration that is applicable to an authentication device 101.

FIG. 3 is a flowchart of operation of the authentication device 101.

FIG. 4A is a diagram illustrating an example of display of an authentication screen.

FIG. 4B is a diagram illustrating an example of display of an authentication screen.

FIG. 5 is a flowchart for explaining processing in step S308 in detail.

FIG. 6 is a diagram illustrating an example of a configuration of token information.

FIG. 7 is a flowchart for explaining operation of a service providing device 102.

FIG. 8 is a diagram illustrating an example of a screen for setting a TOTP method as a second authentication method.

FIG. 9 is a flowchart for explaining step S308 in detail.

FIG. 10 is a diagram illustrating an example of a configuration of JSON data obtained by decoding claims included in an ID token.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

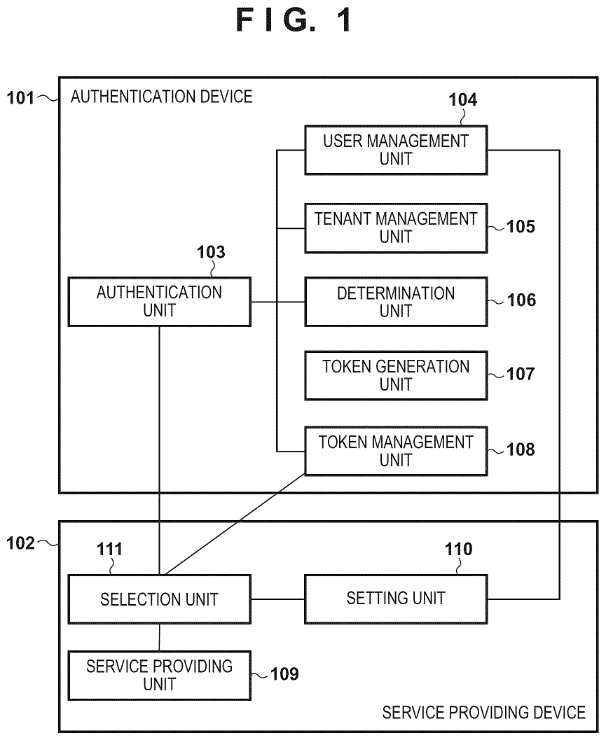

As illustrated in a block diagram of FIG. 1, an authentication system according to the present embodiment includes an authentication device 101, which performs user authentication, and a service providing device 102, which provides a service to a user who has succeeded in authentication. The authentication device 101 and the service providing device 102 are configured to be capable of data communication with each other through a network, such as a LAN or the Internet.

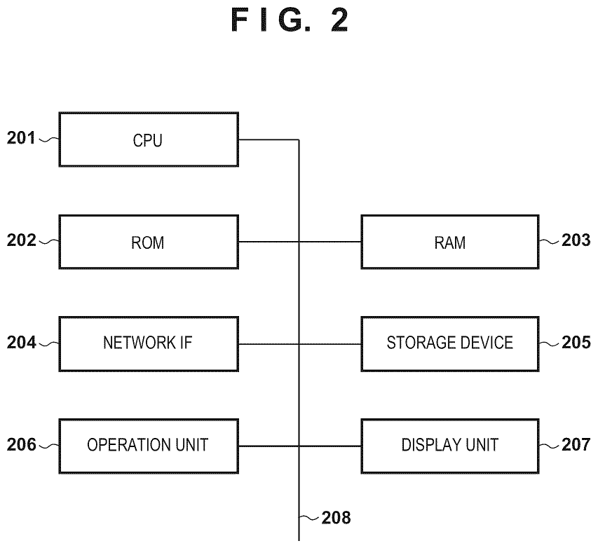

An example of a hardware configuration applicable to the authentication device 101 will be described with reference to the block diagram of FIG. 2.

A CPU 201 executes various processes using computer programs and data stored in a RAM 203. The CPU 201 thus performs control of operation of the entire authentication device 101 and executes or controls various processes described as processes to be performed by the authentication device 101.

A ROM 202 stores setting data of the authentication device 101, computer programs and data related to startup of the authentication device 101, computer programs and data related to a basic operation of the authentication device 101, and the like.

The RAM 203 includes an area for storing computer programs and data loaded from the ROM 202 and a storage device 205. Further, the RAM 203 includes an area for storing computer programs and data received from an external apparatus (e.g., service providing device 102) via a network I/F 204. Further, the RAM 203 includes a work area that the CPU 201 uses when executing various processes. The RAM 203 can thus provide various areas as appropriate.

The network I/F 204 is an interface for connecting the authentication device 101 to the above network, and the authentication device 101 performs data communication with the service providing device 102 through the network I/F 204.

The storage device 205 is a non-volatile mass information storage device, such as a hard disk drive device. The storage device 205 stores an operating system (OS), computer programs and data for causing the CPU 201 to execute or control various processes described as processes to be performed by the authentication device 101, and the like.

An operation unit 206 is a user interface, such as a keyboard, a mouse, and a touch panel screen, and can input various kinds of instructions and information to the authentication device 101 by being operated by a user.

A display unit 207 includes a liquid crystal screen or a touch panel screen and can display a result of processing by the CPU 201 by using images, characters, and the like. The display unit 207 may be a projection device such as a projector for projecting images and characters.

The CPU 201, the ROM 202, the RAM 203, the network I/F 204, the storage device 205, the operation unit 206, and the display unit 207 are all connected to a system bus 208. The hardware configuration illustrated in FIG. 2 is merely one example of a hardware configuration applicable to the authentication device 101 and can be appropriately modified/changed.

In the present embodiment, description will be given assuming that the service providing device 102 also has the hardware configuration illustrated in FIG. 2, but the hardware configuration of the service providing device 102 is not limited to the hardware configuration illustrated in FIG. 2.

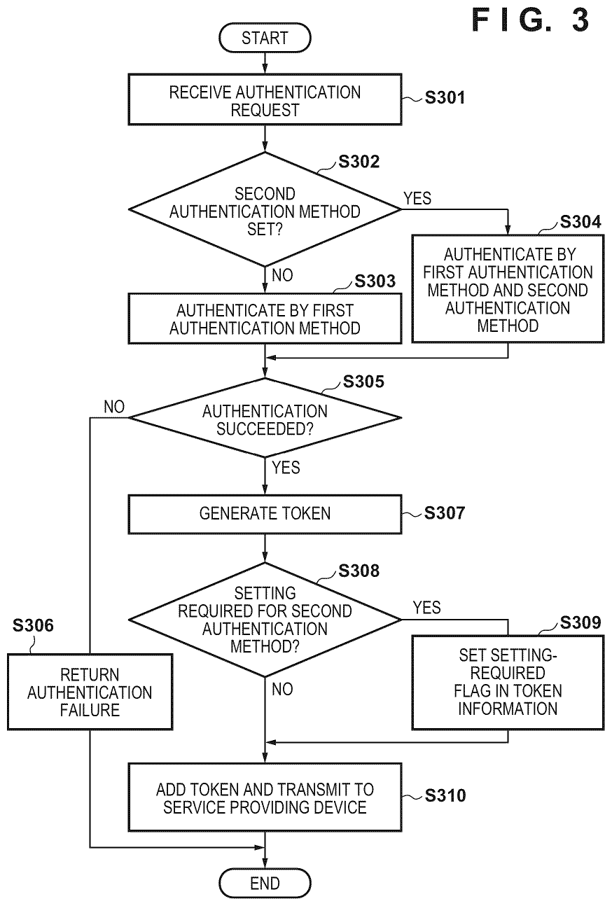

Next, the operation of the authentication device 101 will be described in accordance with the flowchart of FIG. 3. In the present embodiment, a case where each functional unit illustrated in FIG. 1 is implemented by software (computer program) will be described. Further, in the following, each functional unit illustrated in FIG. 1 will be described as a performer of processing. However, in practice, the CPU 201 of the authentication device 101 realizes a function corresponding to each functional unit of the authentication device 101 by executing a computer program corresponding to that functional portion. Further, the CPU 201 of the service providing device 102 realizes a function corresponding to a respective functional unit of the service providing device 102 by executing a computer program corresponding to that functional portion. One or more of the functional units illustrated in FIG. 1 may be implemented by hardware.

In step S301, an authentication unit 103 obtains an authentication request from the user.

In step S302, a user management unit 104 determines whether the user is a “user for whom a second authentication method different from a first authentication method has not been set” or a “user for whom the second authentication method has been set”.

In the present embodiment, the first authentication method is an authentication method in which user authentication is performed using a user ID and a password. In the present embodiment, the second authentication method is an authentication method in which user authentication is performed using a one-time password that is based on a Time-based One-Time Password (TOTP) method.

As a result of such determination, if the user is a “user for whom the second authentication method has not been set” the processing proceeds to step S303. Meanwhile, if the user is a “user for whom the second authentication method has been set” the processing proceeds to step S304.

In step S303, the authentication unit 103 authenticates the user by the first authentication method. In step S304, the authentication unit 103 authenticates the user by the first authentication method, and if the authentication has succeeded, the user is authenticated by the second authentication method.

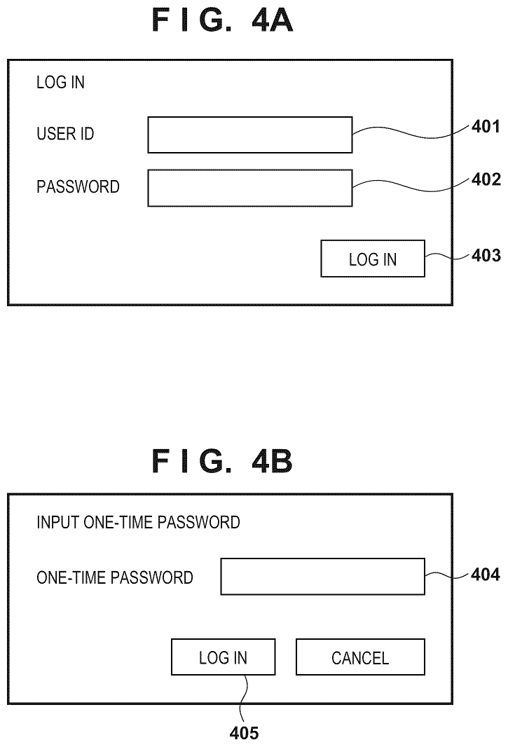

Here, an example of processing from steps S301 to S304 will be described. In step S301, the authentication unit 103 displays an authentication screen illustrated in FIG. 4A on the display unit 207 of the authentication device 101 and prompts the user to input a user ID and a password. Then, upon the user operating the operation unit 206 to input a user ID and a password in respective fields 401 and 402 and then making an instruction on a log-in button 403, the authentication unit 103 obtains the inputted user ID and password as an authentication request.

In step S302, the user management unit 104 determines whether a secret corresponding to the user ID entered in the field 401 is registered in the user management unit 104. As a result of this determination, if a secret corresponding to the inputted user ID is registered in the user management unit 104, the user management unit 104 determines that the user corresponding to the inputted user ID is a “user for whom the second authentication method has been set”. Meanwhile, if a secret corresponding to the inputted user ID is not registered in the user management unit 104, the user management unit 104 determines that the user corresponding to the inputted user ID is a “user for whom the second authentication method has not been set”.

In step S303, the authentication unit 103 determines whether a set of the user ID and the password inputted in respective fields 401 and 402 is registered in the authentication device 101. As a result of this determination, if it is determined to be registered, it is determined that authentication by the first authentication method has succeeded, and if it is determined to be not registered, it is determined that authentication by the first authentication method has failed.

In the TOTP method, a secret for issuing a one-time password to the user is issued in advance. On the user side this secret is registered in an authentication application that operates on a terminal device, such as a PC or a smartphone, while the same secret is registered in the user management unit 104 of the authentication device 101.

In step S304, the authentication unit 103 performs authentication by the first authentication method as in step S303. Then, upon success of authentication by the first authentication method, the authentication unit 103 causes the display unit 207 of the authentication device 101 to display an authentication screen illustrated in FIG. 4B and prompts input of a one-time password generated by the authentication application based on the secret and valid only for a certain period of time. The user operates the operation unit 206 to input a one-time password generated by the authentication application based on the secret in a field 404. Then, upon the user operating the operation unit 206 to make an instruction on a log-in button 405, the authentication unit 103 similarly generates a one-time password based on a “secret corresponding to the user ID” registered in the user management unit 104 and determines whether the generated one-time password matches the one-time password entered in the field 404. As a result of such determination, if the one-time passwords match, it is determined that authentication by the second authentication method has succeeded, and if the one-time passwords do not match, it is determined that authentication by the second authentication method has failed.

The first authentication method and the second authentication method are not limited to the above particular authentication methods, and other types of authentication methods may be employed as two-step authentication or multi-factor authentication methods. Further, the processing of steps S301 to S304 may be appropriately changed according to the first authentication method and the second authentication method.

In step S305, the authentication unit 103 determines whether authentication (authentication by the first authentication method if the processing has proceeded from step S303 to step S305, and both authentication by the first authentication method and authentication by the second authentication method if the processing has proceeded from step S304 to step S305) has succeeded. As a result of this determination, if authentication has failed, the processing proceeds to step S306, and if authentication has succeeded, the processing proceeds to step S307.

In step S306, the authentication unit 103 outputs information indicating that authentication has failed (e.g., a message indicating that authentication has failed). An output method and output destination of the information indicating that authentication has failed is not limited to a particular case.

In step S307, a token generation unit 107 generates a token corresponding to an authentication success, generates token information, which is information related to the token, and registers the generated token information in a token management unit 108.

In step S308, it is determined whether the second authentication method needs to be set (setting is required) for the successfully authenticated user. As a result of such determination, if it is determined that the second authentication method needs to be set (setting is required) for the successfully authenticated user, the processing proceeds to step S309. Meanwhile, if it is determined that the second authentication method does not need to be set (setting is not required) for the successfully authenticated user, the processing proceeds to step S310. The processing in step S308 will be described later in detail.

In step S309, the token generation unit 107 updates (sets) the value of a setting-required flag, which is included in the token information registered in the token management unit 108 in step S307, to a “value indicating that the second authentication method needs to be set (setting is required)”.

In step S310, the authentication unit 103 transmits, to the service providing device 102, a response to which the token generated in step S307 has been added. For example, the authentication unit 103 receives an authentication request in an HTTP request, generates a response in which a token has been added to a cookie as a response to the authentication request, and transmits (redirects) the response to the service providing device 102. A method of transmitting a token to the service providing device 102 is not limited to a particular method.

Here, the token generated by the token generation unit 107 may be any form of information. For example, the token is a character string, such as a UUID, and the token information for UUID is managed by the token management unit 108.

FIG. 6 illustrates an example of a configuration of token information managed by the token management unit 108. “id” is an ID of a token and is used as a key for searching for token information corresponding to the token. “username” is an ID for identifying a user. “tenant_id” is an ID for identifying a tenant to which the user belongs. “preferred_username” is a login ID used by the user for authentication requests, and here, an email address is used as a login ID. “auth_time” is the Unix time for the time the user was successfully authenticated. “require_mfa” is a setting-required flag and indicates that setting is required if its value is true and that setting is not required if its value is false. The default value of “require_mfa” is false, and in step S309, the token generation unit 107 updates the value of “require_mfa” to true.

The configuration of the token information is not limited to a particular configuration, and for example, the token information may be included in a token character string, such as an ID token defined by Open ID Connect, and a setting-required flag may be added thereto.

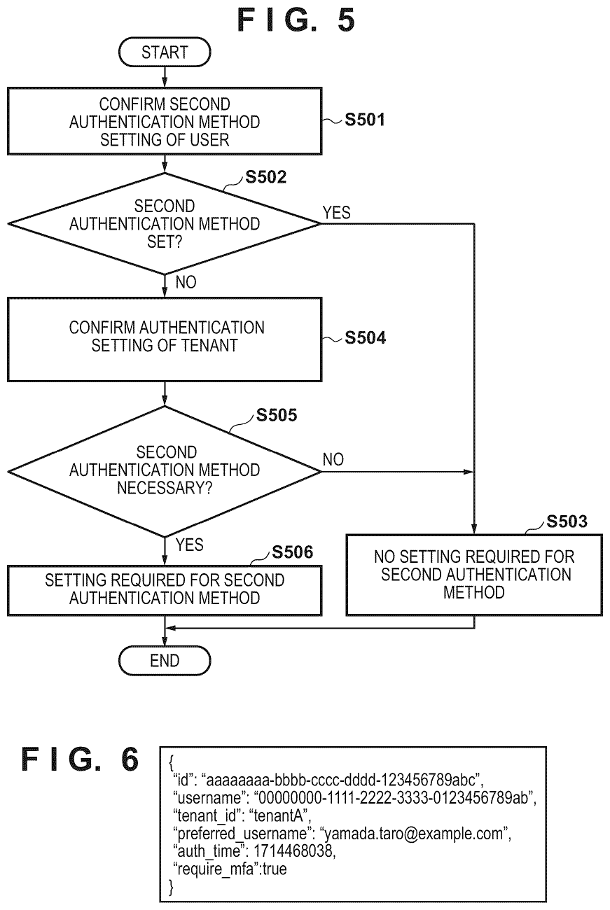

Next, the processing in above step S308 will be described in detail in accordance with the flowchart of FIG. 5. In step S501, the user management unit 104 confirms whether it is determined that the user is a “user for whom the second authentication method has not been set” or a “user for whom the second authentication method has been set” in the determination in step S302.

As a result of this confirmation, if it is determined that the user is a “user for whom the second authentication method has not been set”, the processing proceeds to step S504 through step S502. Meanwhile, as a result of this confirmation, if it is determined that the user is a “user for whom the second authentication method has been set”, the processing proceeds to step S503 through step S502.

In step S503, a determination unit 106 determines that the second authentication method does not need to be set (setting is not required) for the user. In step S504, a tenant management unit 105 confirms pre-registered setting information on the user's affiliation (e.g., tenant in the present embodiment). In the tenant, an administrator of an organization corresponding to the tenant performs authentication setting based on a policy, such as whether multi-factor authentication is necessary, and the result of the authentication setting is reflected in the setting information.

In step S505, the tenant management unit 105 determines whether the setting information indicates that “the second authentication method is necessary as the authentication setting of the tenant”. As a result of this determination, if the configuration information indicates that “the second authentication method is necessary as the authentication setting of the tenant”, the processing proceeds to step S506. Meanwhile, as a result of this determination, if the configuration information does not indicate that “the second authentication method is necessary as the authentication setting of the tenant”, the processing proceeds to step S503.

In step S506, the determination unit 106 determines that authentication by the second authentication method is necessary based on the user's affiliation but not set for the user and thus the second authentication method needs to be set (setting is required) for the user.

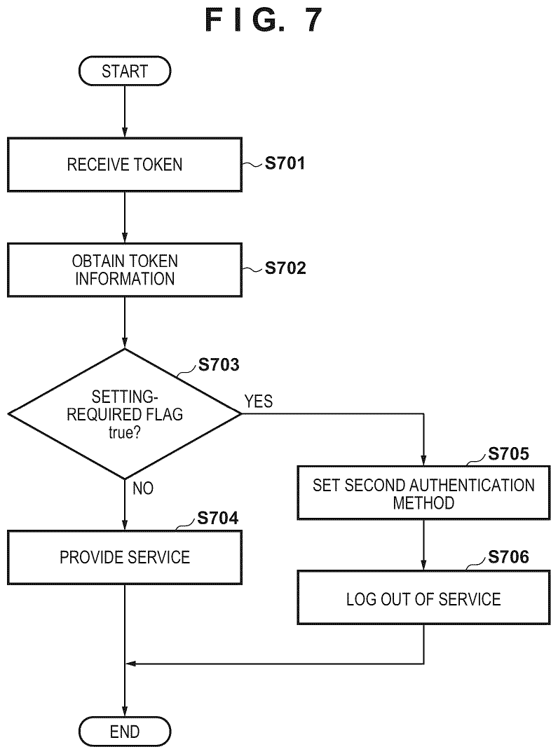

Next, the operation of the service providing device 102 will be described in accordance with the flowchart of FIG. 7. In step S701, a selection unit 111 receives a response (token) transmitted from the authentication device 101.

In step S702, the selection unit 111 obtains, from the authentication device 101 (token management unit 108), token information of the token received in step S701. For example, the selection unit 111 generates a request for token information corresponding to an ID included in the token (ID of the token) and transmits the generated request to the authentication device 101. The token management unit 108 in the authentication device 101 obtains token information (in the case of FIG. 6, token information having an ID included in the token as “id”) requested by the request received from the service providing device 102 from token information being managed. The token management unit 108 transmits the obtained token information to the service providing device 102 as a response to the request.

If the token management unit 108 does not have token information requested by the request received from the service providing device 102 in the managed token information or the token is expired in the managed token information, the service providing device 102 does not perform processing for providing a service.

If the selection unit 111 has succeeded in obtaining the token information, the processing proceeds to step S703. In step S703, the selection unit 111 determines whether the value of the setting-required flag included in the token information obtained in step S702 is true. As a result of this determination, if the value of the setting-required flag included in the token information obtained in step S702 is true, the processing proceeds to step S705. Meanwhile, if the value of the setting-required flag included in the token information obtained in step S702 is false, the processing proceeds to step S704.

In step S704, a service providing unit 109 executes processing for providing a service. Meanwhile, in step S705, the service providing unit 109 does not execute processing for providing a service, and a setting unit 110 performs processing for prompting the user to set the second authentication method. For example, the service providing unit 109 does not perform screen display for a service, and the setting unit 110 causes the display unit 207 of the service providing device 102 to display a setting screen for setting the second authentication method.

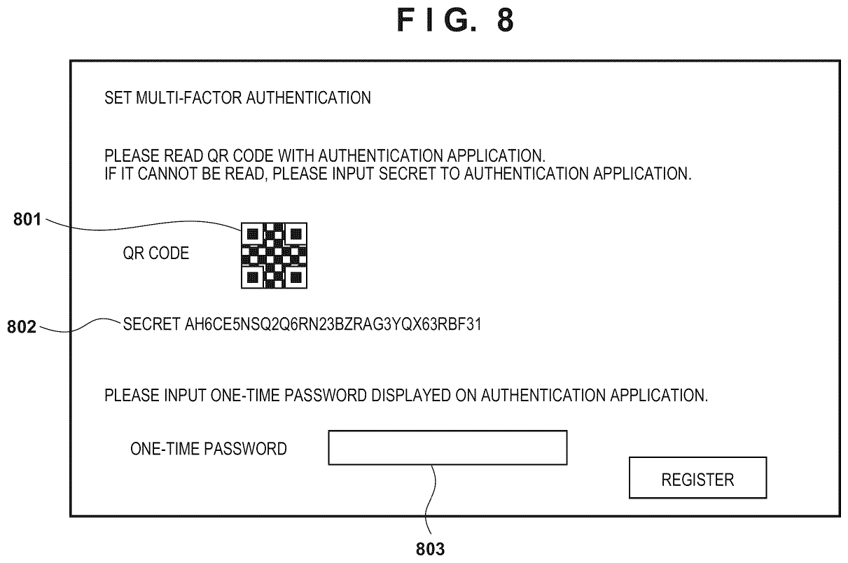

FIG. 8 illustrates an example of a screen for setting the TOTP method as the second authentication method. The setting screen is displayed on the display unit 207 of the service providing device 102 by the setting unit 110 of the service providing device 102 as part of a user management screen, after the user has logged in to the service providing device 102.

The user registers the secret in the authentication application by operating the terminal device to read a “QR code 801, which includes information on a secret 802 of the user” displayed on the setting screen by using the authentication application or by directly inputting the secret 802 into the authentication application. Since the terminal device can thus generate and display a one-time password corresponding to the registered secret by using the authentication application, the user operates the operation unit 206 of the service providing device 102 to input and register the displayed one-time password in a field 803. The user management unit 104 of the authentication device 101 holds the secret (secret 802) corresponding to the QR code 801. The terminal device transmits the registered one-time password to the authentication device 101. If that one-time password and the one-time password generated by the secret held in the user management unit 104 match, the user management unit 104 sets the second authentication method for the user (registers the secret of the user in the user management unit 104). The user is thus managed as a “user for whom the second authentication method has been set”.

The screen for setting the second authentication method is not limited to the setting screen illustrated in FIG. 8. For example, in a case of using a one-time password notification by SMS as the second authentication method, an SMS transmission destination phone number is registered.

Upon completion of setting of the second authentication method, the processing proceeds to step S706. In step S706, the selection unit 111 prompts the user to log out of the service providing device 102 and causes the authentication device 101 to display the authentication screen for the first authentication method illustrated in FIG. 4A on the display unit 207 of the authentication device 101. Thereafter, similar to the flowchart of FIG. 3, upon success of authentication by the first authentication method, the authentication device 101 displays the authentication screen for the second authentication method illustrated in FIG. 4B on the display unit 207. Then, upon success of authentication by the first authentication method and authentication by the second authentication method, the authentication device 101 generates a token corresponding to an authentication success and token information of the token. At this point, since the second authentication method has already been set, the setting-required flag will not be true, and thus, in step S704, the service providing unit 109 executes processing for providing a service.

The reason for logging out once is to change to another token and set the setting-required flag of the token to the default value false, but this is not necessary. Even without a logout, the value of the setting-required flag held in the token management unit 108 of the authentication device 101 may be updated in a stage after the second authentication method has been set in step S705, for example. Then, after step S705, the processing may directly transition to step S704 and the service providing unit 109 may execute the processing for providing a service.

Thus, in the present embodiment, if a user for whom the second authentication method needs to be set but is not set has been authenticated, a flag with a value indicating that setting is required is included in the token information. The service providing device can thus determine whether to prompt the user to set the second authentication method merely by confirming the token information, without querying the authentication device for the authentication setting of the tenant or the second authentication method setting status of the user.

### Second Embodiment

In each of the following embodiments including the present embodiment, differences from the first embodiment will be described, and unless otherwise mentioned below, it is assumed that the rest is the same as the first embodiment. In the first embodiment, depending on whether the second authentication method is necessary as the authentication setting of the tenant, the setting-required flag has been set for a user for whom the second authentication method has not been set. In contrast, in the present embodiment, depending on the setting status of one or more users belonging to the tenant, the value of the setting-required flag is set to true for a user for whom the second authentication method has not been set.

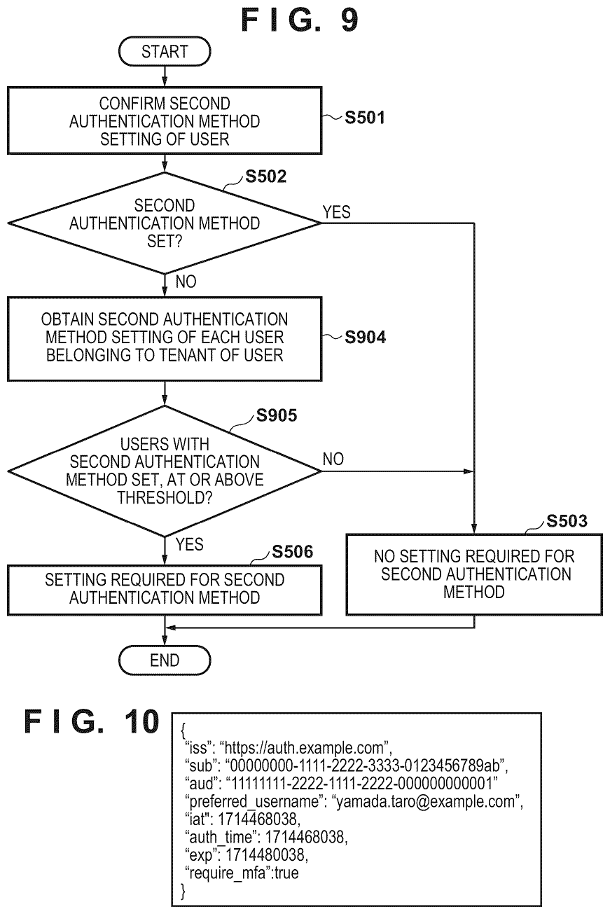

Step S308 according to the present embodiment will be described in detail in accordance with the flowchart of FIG. 9. In FIG. 9, processing steps similar to the processing steps of FIG. 5 will be given the same step numbers as those processing steps, and description for those processing steps will be omitted.

As a result of the confirmation in step S501, if it is determined that the user is a “user for whom the second authentication method has not been set”, the processing proceeds to step S904 through step S502. In step S904, the determination unit 106 obtains “information indicating whether the second authentication method has been set”, which is managed for each user belonging to the user's affiliation (e.g., a tenant in the present embodiment).

In step S905, the determination unit 106 obtains a proportion of users for whom the second authentication method has been set among users belonging to the user's affiliation, based on the information obtained for each user in step S904. Then, the determination unit 106 determines whether the determined proportion is at or above a threshold. As a result of this determination, if the obtained proportion is at or above the threshold, the processing proceeds to step S506, and if the obtained proportion is below the threshold, the processing proceeds to step S503.

Thus, in the present embodiment, if a proportion of users for whom the second authentication method has been set in the tenant to which the user belongs is higher than that of users for whom the second authentication method has not been set, the value of the setting-required flag of the token information is set to true. Thus, it is possible to request or recommend that the user set the second authentication method in consideration of the second authentication method setting statuses within the same tenant.

### Third Embodiment

In the above embodiments, description has been given assuming that the token information including the setting-required flag and illustrated in FIG. 6 is held in the token management unit 108 and the selection unit 111 of the service providing device 102 requests for and obtains the token information from the authentication device 101 in step S702. However, there is no limitation thereto, and the character string of the token generated by the token generation unit 107 may include the setting-required flag. This makes it possible for the selection unit 111 to determine whether to prompt the user to set the second authentication method based on the setting-required flag included in the token, without requesting for the token information from the authentication device 101. In particular, there is an ID token as a commonly used token specification. An ID token includes an encoded header and claims, and by including the setting-required flag in the claims, it is possible to determine whether to set the second authentication method.

FIG. 10 illustrates an example of a configuration of JSON data obtained by decoding claims included in an ID token. In FIG. 10, the token generation unit 107 adds “require_mfa” to the claims and data, such as true or false, as its value. The selection unit 111 of the service providing device 102 can select whether to execute processing for providing a service or set the second authentication method in step S703 depending on the setting-required flag included in the ID token.

That is, various methods can be applied to a method for achieving the purpose of notifying the service providing device 102 of whether the second authentication method needs to be set (setting is required). Therefore, if it is possible to achieve such a purpose, the service providing device 102 may be notified of the setting-required flag by any method, and information other than the setting-required flag may be used.

The display timings and configurations of the various screens described in the above embodiments are only one example and are not limited to particular display timings and configurations. For example, two or more screens may be combined into one screen.

### Fourth Embodiment

In each of the above embodiments, a case where a user who receives a service by the service providing device 102 is authenticated by the authentication device 101 has been described, but it may be a case where a user who uses a device other than the service providing device 102 is authenticated by the authentication device 101.

The numerical values, processing timing, processing order, processing performer, data (information) configuration/obtainment method/transmission destination/transmission source/storage location, and the like used in the above embodiments have been given as examples for the sake of providing a concrete explanation, and the present disclosure is not intended to be limited to such examples.

Further, some or all of the embodiments described above may be appropriately combined and used. Further, some or all of the embodiments described above may be selectively used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-109091, filed Jul. 5, 2024, which is hereby incorporated by reference herein in its entirety.

What is claimed is:

1. An authentication device comprising:
an authentication unit configured to authenticate by a first authentication method a user for whom a second authentication method, which is different from the first authentication method, has not been set and authenticate by the first authentication method and the second authentication method a user for whom the second authentication method has been set; and
a setting unit configured to determine whether authentication by the second authentication method is necessary for the user for whom the second authentication method has not been set and if it is determined to be necessary, set information indicating that authentication by the second authentication method is necessary.

2. The authentication device according to claim 1, wherein
the setting unit,
if it has been set that authentication by the second authentication method is necessary for an affiliation of the user for whom the second authentication method has not been set, sets the information.

3. The authentication device according to claim 1, wherein
the setting unit,
if a proportion of users for whom the second authentication method has been set is at or above a threshold in an affiliation of the user for whom the second authentication method has not been set, sets the information.

4. The authentication device according to claim 1, wherein
the setting unit sets the information in token information related to a token generated when authentication by the authentication unit succeeds.

5. The authentication device according to claim 4, further comprising:
a transmission unit configured to transmit the token to another device and, upon reception of a request for token information related to the token from the other device, transmit the token information to the other device.

6. The authentication device according to claim 1, wherein
the setting unit sets the information in a token generated when authentication by the authentication unit succeeds.

7. The authentication device according to claim 1, further comprising:
a transmission unit configured to transmit the token to another device.

8. An authentication system including an authentication device and a service providing device,
the authentication device comprising:
an authentication unit configured to authenticate by a first authentication method a user for whom a second authentication method, which is different from the first authentication method, has not been set and authenticate by the first authentication method and the second authentication method a user for whom the second authentication method has been set; and
a setting unit configured to determine whether authentication by the second authentication method is necessary for the user for whom the second authentication method has not been set and if it is determined to be necessary, set information indicating that authentication by the second authentication method is necessary,
the service providing device comprising:
a processing unit configured to, in a case where the information is set, perform processing for setting authentication by the second authentication method for the user for whom the second authentication method has not been set.

9. The authentication system according to claim 8, wherein
in a case where the information is set, the processing unit does not perform processing for providing a service.

10. The authentication system according to claim 8, wherein
after authentication by the second authentication method has been set for the user for whom the second authentication method has not been set, the processing unit logs out the user from the service providing device.

11. An authentication method performed by an authentication device, the method comprising:
authenticating by a first authentication method a user for whom a second authentication method, which is different from the first authentication method, has not been set and authenticating by the first authentication method and the second authentication method a user for whom the second authentication method has been set; and
determining whether authentication by the second authentication method is necessary for the user for whom the second authentication method has not been set and if it is determined to be necessary, setting information indicating that authentication by the second authentication method is necessary.

12. A non-transitory computer-readable storage medium storing a computer program for causing
a computer to function as:
an authentication unit configured to authenticate by a first authentication method a user for whom a second authentication method, which is different from the first authentication method, has not been set and authenticate by the first authentication method and the second authentication method a user for whom the second authentication method has been set; and
a setting unit configured to determine whether authentication by the second authentication method is necessary for the user for whom the second authentication method has not been set and if it is determined to be necessary, set information indicating that authentication by the second authentication method is necessary.
